(19) United States
(12) Patent Application Publication
(10) Pub. No.: US 2024/0408907 A1
(43) Pub. Date: Dec. 12, 2024

(54) INKJET RECORDING SYSTEM AND PRINT INFORMATION CORRECTION METHOD

(71) Applicant: Hitachi Industrial Equipment Systems Co., Ltd., Tokyo (JP)

(72) Inventors: Muhammad Izzat Firdaus BIN ZAILUDDIN, Tokyo (JP); Takuya MORIAI, Tokyo (JP); Manabu KATO, Tokyo (JP); Ryuuta MOTOYANAGI, Tokyo (JP)

(21) Appl. No.: 18/697,546

(22) PCT Filed: May 30, 2022
(86) PCT No.: PCT/JP2022/022016

§ 371 Date: Apr. 1, 2024

(30) Foreign Application Priority Data
Oct. 18, 2021 (JP) 2021-170524

(51) Int. Cl. B41J 29/393; B41J 2/21

(52) U.S. Cl. CPC B41J 29/393; B41J 2/2135; B41J 2029/3935; B41J 2203/01

(57) ABSTRACT

An inkjet printer prints predetermined information comprising dots formed by the ejected ink onto the print target. Images are captured of the predetermined information printed. The printing area of the predetermined information is detected from the image and a criteria position grid in which each of the predetermined divided dot areas is assigned with a dot as a criteria for inspecting the landing position is generated. The dot landing position is inspected relative to the criteria dot position based on a superimposed image of the printing area and the criteria position grid and a degree of displacement of the dot landing position relative to the criteria dot position is determined. A feedback signal for correcting the dot landing position is generated based on the result of the inspection and ink is ejected on the print target based on the corrected dot landing position obtained from the feedback signal.

### BACKGROUND OF THE INVENTION

### 1. Field of the Invention

Related to inkjet recording system and print information correction method.

### 2. Description of the Related Art

The manufacture date, best-before date, production lot, etc. are legally required to be displayed on food and drug packaging containers, and inkjet recording units and other printing units make this possible. The inkjet recording units are set on conveyor lines (including packaging lines) to print on packaging containers that are conveyed one after another.

The correctness of printing by the printing unit is verified by a printing inspection unit that reads the printing on the packaging container. In addition, recently, not only characters are printed, but also various information necessary for manufacturing history management is recorded. Therefore, 2D code printing, which can record a large amount of information, is increasingly being printed at the same time, and it is necessary to inspect whether this 2D code information is printed correctly.

The background technology of this printing inspection unit is, for example, patent document 1. In a direct marking system equipped with a code marking unit that forms the code read by the code reading unit on the surface of the object, the code reading unit and the code marking unit are communicably connected to each other, and the signal processing unit feeds back evaluation results of the quality of the marking formed on the surface of the object to the code marking unit. The featured direct marking system is described.

### CITATION LIST

### Patent Document

Patent Document 1: JP publication No. 2009-187065

### SUMMARY OF THE INVENTION

### Problems to be Solved by the Invention

The inkjet recording unit charges ink particles that are continuously ejected from the nozzle at a certain frequency. The charged ink particles are changed in flight trajectory by the electric field between the deflection electrodes of the deflection electrode and land on the print target. The amount of charge applied to each continuously ejected ink particle is changed, the charged ink particles are deflected by the deflection electric field, and the dots that land on the print target form characters.

Charging is performed by applying a voltage to an electrode called a charged electrode. The position at which ink particles land on the print target varies depending on the charge amount. Changes in line speed, ink viscosity, and the distance between the print target and the ink particle ejection port of the print head of the inkjet recording unit, in other words, changes in printing distance, cause changes in printing distortion and the criteria landing position of the ink particles. The print distortion is one of the factors that deteriorate the reading accuracy of 2D codes and the like.

In the patent document 1, in a direct marking system equipped with a code marking unit that forms a code read by a code reading unit on the surface of an object, the code reading unit and the code marking unit are communicably connected to each other, and the signal processing unit feeds back the evaluation result of the quality of the marking formed on the surface of the object to the code marking unit. However, the control disclosed in the patent document 1 above is a laser marker-specific control, and no clear feedback control is described. For example, in paragraph 0016 of the patent document 1, it is stated that the output and position of the print head is controlled when the code marking unit is an inkjet system. However, there is no disclosure of specific control, and the technology cannot be applied to inkjet recording units as it is. In other words, when the inkjet recording unit reads and evaluates the 2D code printed by the inkjet recording unit and feeds back the evaluation results, what kind of control is performed is not disclosed. Therefore, in the case of inkjet recording units, it cannot be the 2D code evaluation and feedback control based on such evaluation are necessarily performed appropriately. This is true not only for 2D codes, but also for various types of printed information such as strings, symbols, numbers, codes, etc., which are composed of dots that are landed from the inkjet recording unit.

An object of the present invention is to provide the inkjet recording system and the method for correcting printed information that can appropriately evaluate printed information printed by the inkjet recording unit and perform feedback control based on the evaluation.

### Solutions to Problems

The inkjet recording system according to the present invention comprises: an inkjet printer for ejecting ink onto a print target and printing predetermined information comprising dots formed by the ejected ink onto the print target, a camera capturing images of the predetermined information printed on the print target, a detection unit for detecting the printing area of the predetermined information from the image captured the predetermined information, a criteria position grid unit for dividing the detected printing area into predetermined dot areas and generating a criteria position grid in which each of the divided dot areas is assigned with a dot as a criteria for inspecting the landing position, a reading determination unit for inspecting the dot landing position relative to the criteria dot position based on a superimposed image of the printing area and the criteria position grid and a determination grade criteria table to determine the degree of displacement of the dot landing position relative to the criteria dot position, a processing unit including a dot position correction unit for generating a feedback signal for correcting the dot landing position based on the result of the inspection and the correction data defining the correction amount of the dots comprising the printing area determined according to the degree of the displacement and outputting to the inkjet printer, wherein the inkjet printer ejects ink on the print target based on the corrected dot landing position obtained from the feedback signal.

### Effects of the Invention

According to the present invention, it is possible to appropriately evaluate printed information printed by the inkjet recording unit and perform feedback control based on the evaluation.

### BRIEF DESCRIPTION OF THE DRAWINGS

FIG. 1 shows an example of an inkjet automatic correction system.

FIG. 2 shows an example of a block diagram of the inkjet recording unit and the printing inspection unit in this example.

FIG. 3 shows an example of a computer schematic diagram.

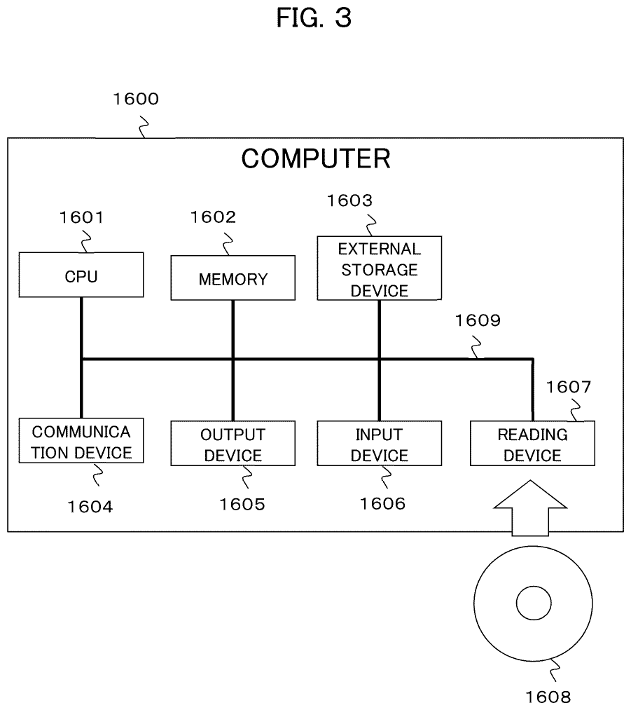

FIG. 4 shows an example of a determination item table showing evaluation criteria based on ISO 15415 is shown in the figure.

FIG. 5 shows an example of a flowchart describing the processing steps of the automatic correction feedback process.

FIG. 6 shows the relationship between the image-processed 2D code, the criterion position grid that serves as a reference for inspecting the dot landing position that comprise the 2D code, and the superimposed image of the 2D code and the criterion position grid.

FIG. 7 shows an example of a determination grade criteria table.

FIG. 8A shows an example of information indicating a warning about symbol contrast (SC).

FIG. 8B shows an example of a normal 2D code.

FIG. 8C shows an example of a faulty print.

FIG. 8D shows an example of a faulty print.

FIG. 8E shows an example of a faulty print.

FIG. 8F shows an example of a faulty print.

FIG. 9 shows an example of a cause of print quality degradation in the inkjet recording unit.

FIG. 10 shows an example of a wireless run system in which this system is applied.

FIG. 11 shows an example of a correction data table that defines the correction values for adjusting the charge amount of the dots.

### MODE FOR CARRYING OUT THE INVENTION

The following description of embodiments of the invention will be made with reference to the drawings. The following description and drawings are illustrative examples to explain the invention, and have been omitted or simplified as appropriate for clarity of explanation. The invention can also be implemented in various other forms. Unless otherwise limited, each component can be singular or plural.

The position, size, shape, extent, etc. of each component shown in the drawings may not represent the actual position, size, shape, extent, etc., in order to facilitate understanding of the invention. Therefore, the invention is not necessarily limited to the position, size, shape, range, etc. disclosed in the drawings.

In the following explanations, various types of information may be described using expressions such as “database,” “table,” “list,” etc. However, various types of information may be expressed in data structures other than these. XX table”, “XX list”, etc. are sometimes called “XX information” to indicate that they do not depend on any data structure. When expressions such as “identification information,” “identifier,” “name,” “ID,” “number,” etc. are used when describing identification information, they can be substituted for each other.

When there are multiple components having the same or similar functions, the same code may be explained with different subscripts. However, when there is no need to distinguish between these multiple components, the subscripts may be omitted.

In the following description, the process performed by executing the program may be described, but the program is executed by a processor (e.g., CPU (Central Processing Unit), GPU (Graphics Processing Unit)) to perform the defined process, The processor may be the main body of the processing in order to perform the processing while using storage resources (e.g., memory) and/or interface devices (e.g., communication ports) as appropriate. Similarly, the subject of the processing performed by executing the program may be a controller, device, system, computer, or node having a processor. The processing entity that executes the program may be an arithmetic unit, and may include a dedicated circuit (e.g., FPGA (Field-Programmable Gate Array) or ASIC (Application Specific Integrated Circuit)) that performs specific processing. The processing entity that executes the program may be an arithmetic unit.

The program may be installed on a device such as a computer from a program source. The program source may be, for example, a program distribution server or a storage medium readable by a computer. If the program source is a program distribution server, the program distribution server may include a processor and a storage resource that stores the program to be distributed, and the processor of the program distribution server may distribute the program to other computers. In the following description, two or more programs may be realized as one program, or one program may be realized as two or more programs.

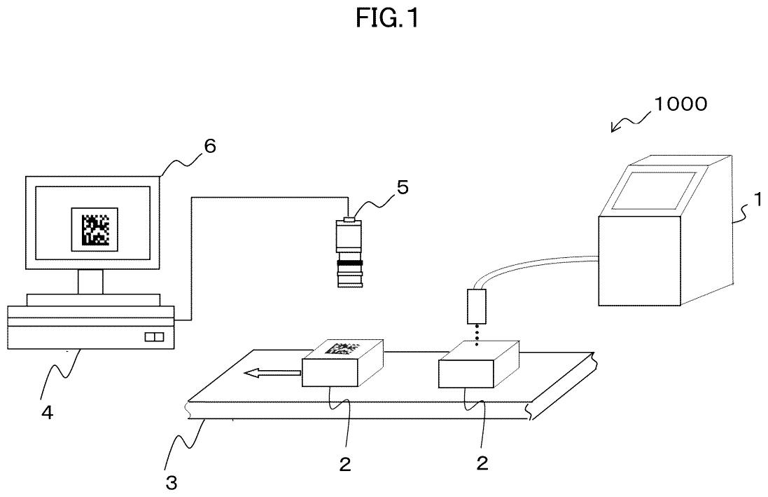

FIG. 1 shows an example of the inkjet recording system 1000. In FIG. 1, the printing inspection unit 4 is a unit that performs printing inspection on a printed object 2 printed by a printing unit such as an inkjet printer (inkjet recording unit) 1. A camera 5 is an image capturing means that reads images including character strings and 2D codes to be inspected. A monitor 6 displays the read images, sets the conditions for the print inspection, and displays the inspection results. Image processing unit 26, which performs processing such as extracting the printed image from the image read by camera 5, controls the amount and timing of illumination, and makes a pass/fail determination of the character to be inspected, and an input/output unit 32 and the like that gives various instructions such as image processing to the image processing unit 26 in the main body of the print inspection unit 4 are comprised. In the following, images including character strings and 2D codes are shown as examples of inspection targets, but images including various information such as symbols, numbers, and signs may also be inspected. In other words, not only dots comprising character strings and 2D codes in the captured images, but also dots comprising various types of information described above may be used as inspection targets.

Thus, the inkjet recording system 1000 comprises an inkjet recording unit 1, a printing inspection unit 4, a camera 5, and a monitor 6. The printing inspection unit 4 uses a camera to read the 2D code printed by the inkjet recording unit, for example, which contains characters and symbols such as the manufacture date, serial number, and other information necessary for manufacturing history management, to determine the quality of printing.

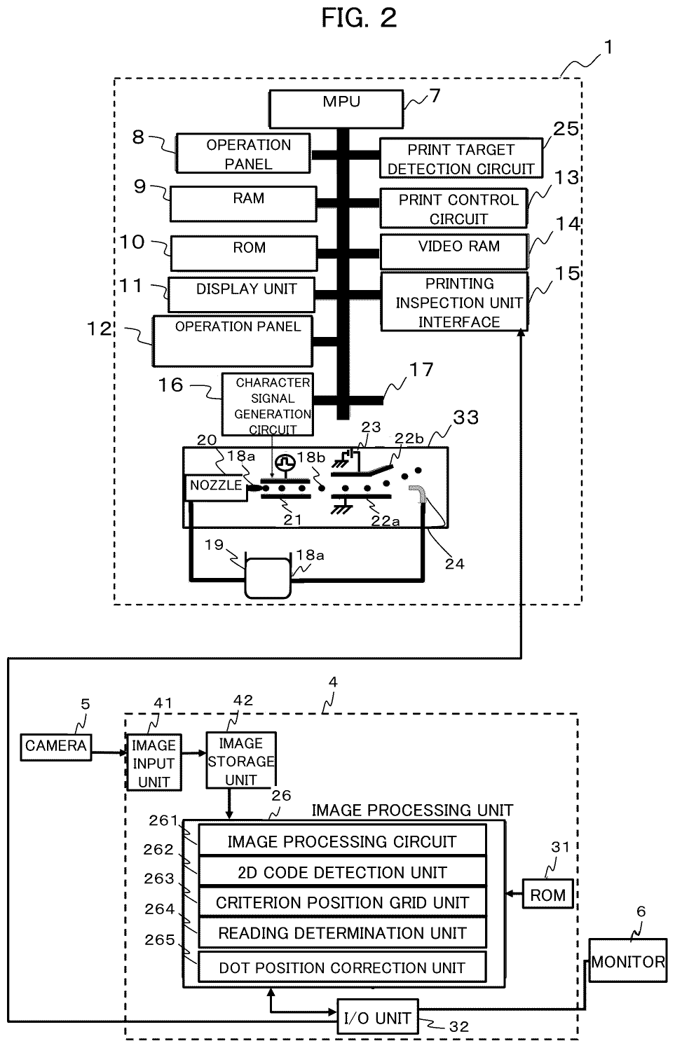

FIG. 2 shows an example of a block diagram of an inkjet recording unit and a printing inspection unit in this example. In FIG. 2, inkjet recording unit 1 comprises an MPU 7 (microprocessing unit) that controls the entire inkjet recording unit, a RAM 9 (random access memory) that temporarily stores data in the inkjet recording unit, a flash memory ROM 10 that stores programs, correction data, etc. in advance, and the contents to be printed, a display unit 11 that displays the contents to be printed, an operation panel 12 that inputs the setting values of printing contents and printing parameters, a print target detection circuit 25 detects print targets, a print speed circuit 8 controls the print speed of the inkjet recording unit 1, and a print control circuit 13 controls an overall printing of the inkjet recording unit 1 other than the print speed, a video RAM 14 that stores video data to charge ink particles 18b, a character signal generation circuit 16 that generates charging voltage to charge ink particles 18b, a printing inspection unit interface 15 that electrically connects to printing inspection unit 4, a printing inspection unit interface 15 is connected to the printing inspection unit 4 by a bus line 17 that sends data, etc.

The print head 33, which is the printing mechanism, comprises an ink container 19 that holds ink 18a, a nozzle 20 that ejects ink, a charged electrode 21 that generates an electric field in the area where the ink 18a ejected from the nozzle 20 separates and becomes ink particles 18b, thereby charging the ink particles 18b, a negative deflection electrode 22a that generates a deflection electric field in the flight path of the ink particles 18b to deflect the charged ink particles 18b, a deflection power 23 that applies a deflection voltage to the positive deflection electrode 22b; a gutter 24 for collecting ink particles 18b not used for printing. The print head 33 pumps ink 18a in the ink container 19 and pressurizes it to supply it to the nozzle 20. Also, inside the print head 33, a piezoelectric transducer is vibrated by a voltage to vibrate the ink and particleize it. The particulate ink 18b is ejected from the orifice portion of the charged electrode 21. The ink particles 18b charged by the charged electrode 21 fly in the electric field between the positive deflection electrode 22b and the negative deflection electrode 22a, and they are deflected by a force proportional to the charge amount while flying in the electric field between the positive deflection electrode 22b and the negative deflection electrode 22a, and fly toward the printed object 2 and land on the printed object 2. At that time, the ink particles 18b change their landing position in the deflection direction according to the charge amount, and characters and figures are printed on the print target by the multiple landing particles. In the following, the case in which the landing position of the ink particles 18b changes in the deflection direction according to the charge amount is exemplified, but the above landing position may be changed according to the frequency of the piezoelectric element in the nozzle.

The printing inspection unit 4 is a unit for inspecting character strings and 2D codes printed by inkjet recording unit 1. As shown in FIG. 2, printing inspection unit 4 includes an image input unit 41 that scans and otherwise reads images input from camera 5, an image storage unit 42 that stores images read by image input unit 41 in a storage medium such as a hard disk drive (HDD), an image processing unit 26 that processes images stored by image storage unit 42, the ROM 31 stores programs to realize the functions of the image processing unit 26 and various data used in this system, and input/output unit 32 for exchanging the above various data with inkjet recording unit 1 and outputting information to monitor 6. The image processing unit 26 comprises an image processing circuit 261, a 2D code detection unit 262, a criterion position grid unit 263, a reading determination unit 264, and a dot position correction unit 265. These functions are described below using flowcharts.

The printing inspection unit 4 shown in FIG. 1, for example, can be realized by a general computer 1600 that includes a CPU 1601, a memory 1602, an external storage device 1603 such as HDD, a reading device 1607 that reads and writes information to and from a portable storage medium 1608 such as CD (Compact Disk) or USB memory, an input device 1606 such as a scanner, keyboard, and mouse, an output device 1605 such as a display, and a communication device 1604 such as a NIC (Network Interface Card) for connecting to a communication network, an internal communication line (referred to as a system bus) 1609 such as a system bus that connects these.

The various data stored in or used for processing by the printing inspection unit 4 can be realized by the CPU 1601 reading from and using memory 1602 or external storage device 1603. In addition, each functional part of each system or device (e.g., the image input unit 41, the image storage unit 42, the input/output unit 32, the image processing unit 26, the image processing circuit 261, the 2D code detection unit 262, the image processing unit 261, the image processing circuit 262, the 2D code detection unit 262, the criteria position grid unit 263, the reading determination unit 264, and the dot position correction unit 265) can be realized by the CPU 1601 loading and executing a predetermined program stored in the external storage device 1603 into the memory 1602.

The predetermined program described above may be stored (downloaded) to an external storage device 1603 from a storage medium 1608 via a reading device 1607 or from a network via communication device 1604, and then loaded onto a memory 1602 and executed by a CPU 1601. It may also be loaded directly onto memory 1602 from storage media 1608 via reading device 1607 or from the network via communication device 1604, and then loaded onto memory 1602 and executed by CPU 1601.

In the following, the case in which printing inspection unit 4 is configured by a single computer is illustrated, but all or part of these functions may be distributed among one or more computers, such as a cloud, and communicate with each other via a network to achieve the same functions may be realized by communicating with each other via a network. The printing inspection unit 4 and the inkjet recording unit 1 may be configured as a single unit. In this case, the monitor 6 and the operation panel of the inkjet recording device 1 may be shared. The specific processing performed by each part of the printing inspection unit 4 is described below using a flowchart.

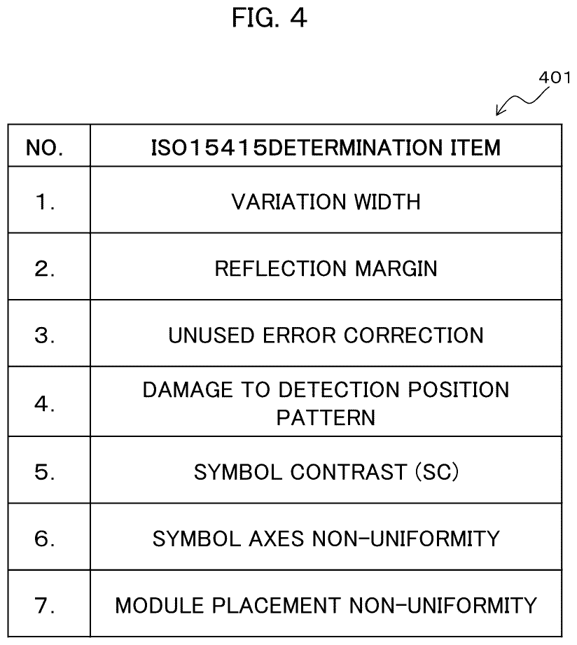

Printing evaluation of 2D code is performed using image data obtained by the printing inspection unit 4 for seven items that indicate evaluation criteria based on ISO 15415. FIG. 4 shows an example of the determination item table indicating the evaluation criteria. 7 items are broken down as shown in FIG. 4, and a determination table 401 includes “displacement width”, “reflection margin”, “unused error correction”, “position detection pattern damage”, “symbol contrast (SC)”, “symbol axis non-uniformity,” and “module placement non-uniformity,” and is evaluated into five levels, A, B, C, D, and F, for each item. The total criteria for print quality is a “B” grade or higher.

“Displacement width” and “reflection margin” are items for evaluating the deviation of the luminance value of each cell in the 2D code image. “Symbol contrast (SC)” is used to evaluate the maximum contrast value of the 2D code image. “Unused error correction” is used to evaluate the percentage of unused error correction when reading 2D code. “Position detection pattern damage” is an evaluation of the fixed pattern of the code. “Symbol axis non-uniformity” is an item for evaluating distortion of 2D code images. “Module placement non-uniformity” is an item for evaluating the amount of cell displacement in the 2D code image. For the overall evaluation, the lowest evaluation level of each item is used as its evaluation. For example, if “displacement width” is evaluation A, “reflection margin” is evaluation A, “unused error correction” is evaluation A, “position detection pattern damage” is evaluation B, “symbol contrast (SC)” is evaluation B, “symbol axis non-uniformity” is evaluation B, the overall evaluation of the 2D code image is evaluation B.

Determination items 1-4 (“displacement width,” “reflection margin,” “unused error correction,” and “position detection pattern damage”) are parameters that can be corrected by the inkjet recording unit. Determination items 5-7 (“symbol contrast (SC),” “symbol axis non-uniformity,” and “module placement non-uniformity”) are parameters that cannot be corrected by the inkjet recording unit.

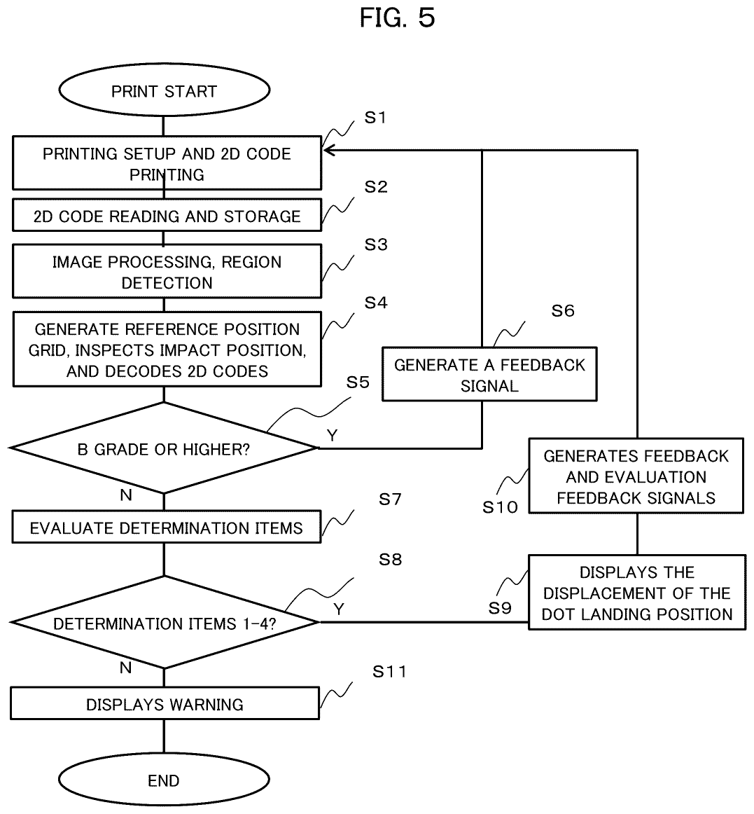

Next, an overview of the processing (automatic correction feedback process) performed by this system is described with reference to FIG. 5. FIG. 5 shows an example of a flowchart describing the processing steps of the automatic correction feedback process.

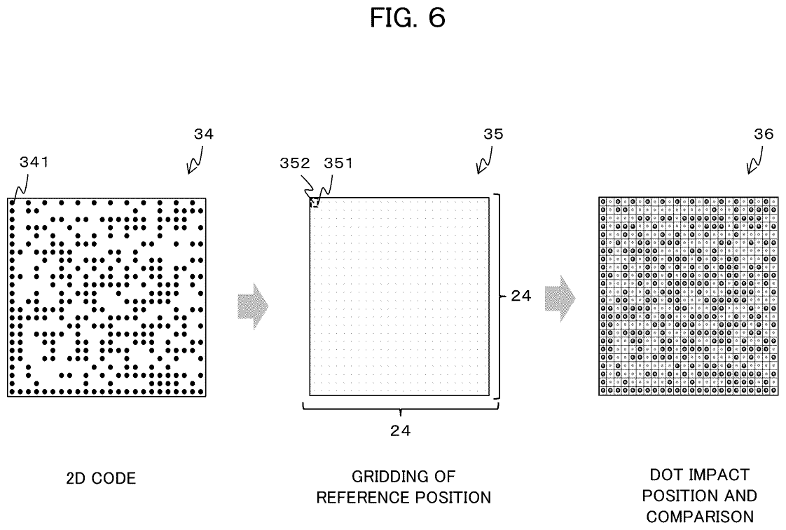

In step 1, the MPU7 of inkjet recording unit 1 sets the contents related to printing input from the user via operation panel 12, controls the operation of print head 33 with the set contents, and prints a character string or 2D code 34 (FIG. 6) is printed on the printed object 2. In the following, the case of printing 2D code will be described, but character strings and other information can be considered in the same way.

In step 2, the printing inspection unit 4 captures the 2D code 34 printed on the printed object 2 by the inkjet recording unit 1 with the camera 5, and the image including the captured 2D code 34 (FIG. 6) is read by the image input unit 41. The image storage unit 42 stores the image read by the image input unit 41 in a storage medium such as HDD.

In step 3, image processing unit 26 displays the image of 2D code stored by image storage unit 42 on monitor 6 and performs image processing such as binarization in image processing circuit 261. The 2D code detection unit 262 detects a 2D code from the processed image. For example, the 2D code detection unit 262 detects the area of the 2D code from the position of the detection pattern in the detected 2D code image.

In step 4, the criterion position grid unit 263 generates a criterion position grid 35 (FIG. 6) that divides the area of the detected 2D code into predetermined dot areas. FIG. 6 illustrates the relationship between the image-processed 2D code, the criterion position grid that serves as a criteria for inspecting the dot landing position that comprise the 2D code, and the superimposed image of the 2D code and the criterion position grid. More specifically, the criterion position grid unit 263 divides the image into dot areas 351 according to the number of dots 341 comprising the 2D code 34 shown in FIG. 6. In FIG. 6, the image is divided into 351 dot areas, which is the same number of dots as the 24 dots that are the maximum number of dots included in the upper and lower vertical limits of the dimensions of the 2D code shown above. Similarly, the 2D code is divided into 351 dot areas, which are the same number of dots as the maximum number of dots included in the upper and lower limits of the horizontal direction that indicate the dimensions of the 2D code above, 24 dots. Thus, the criteria position grid unit 263 generates a grid area that is the source of the criteria position grid 35 with a 24×24 dot area 351 corresponding to each of the dots that make up the 2D code 34. The criteria position grid unit 263 further assigns a criteria dot 352 to the center position of each of the dot areas 351 that comprise the grid area. This generates a criterion position grid 35 that includes a criteria dot 352 at the center position of the dot area 351 corresponding to each of the dots comprising the 2D code 34.

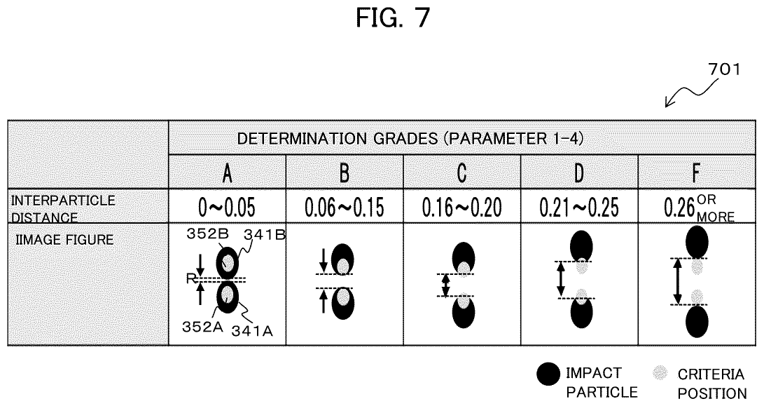

Then, the reading determination unit 264 inspects the dot landing position with respect to the criteria position using a superimposed image 36 in which the 2D code 34 and the criteria position grid 35 generated according to the size of the 2D code 34 are superimposed, and the determination grade criteria table shown in FIG. 7.

FIG. 7 shows an example of a determination grade criteria table. The determination grade criteria table 701 is a table for determining the degree of displacement of the dot landing position relative to the criteria position. As shown in FIG. 7, the determination grade criteria table 701 corresponds the determination grade (5 grades from A to F) of the dot landing position with respect to the criteria position, the distance between particles in each grade, and their images. The determination grade criteria table 701 can be stored in ROM 31 in advance.

For example, to be determined as grade A, the distance between particles, which is the distance between dots, must be within 0 to 0.05 mm when dots exist in adjacent dot areas. This means that, as shown in the image figure, the distance between particles r, as the distance between the nearest sites in dots 341a and 341b, which are adjacent to each other among the dots 341 comprising the 2D code 34, must be within 0 to 0.05 mm. In this case, dots 352a and 352b, which are criteria dots adjacent to each other, are encapsulated in the corresponding dot 341.

For example, to be determined as grade B, the distance between particles, which is the distance between dots, must be within 0.06 to 0.15 mm when dots exist in adjacent dot areas. This means that the distance between particles r, as the distance between the nearest sites mentioned above, must be within 0.06 to 0.15 mm. At this time, dots 352a and 352b, which are adjacent to each other as the criteria dots, are encapsulated by the corresponding dot 341 and share a tangent line between dot 341 and dot 352 as the criteria dots. In other words, the dots 341a and 341b in this state are more separated from each other than in grade A.

For example, to be determined as grade C, the distance between particles, which is the distance between dots, must be within 0.16 to 0.20 mm when dots exist in adjacent dot areas. This means that the distance between particles r, as the distance between the nearest sites mentioned above, must be within 0.16 to 0.20 mm. In this case, the criteria dots 352a and 352b, which are adjacent to each other, are not encapsulated in the corresponding dot 341, and the dots 341a and 341b are further apart than in the case of grade B.

For example, to be determined as grade D, the distance between particles, which is the distance between dots, must be within 0.21 to 0.25 mm when dots exist in adjacent dot areas. This means that the distance between particles r, as the distance between the nearest sites mentioned above, must be within 0.21 to 0.25 mm. In this case, the criteria dots 352a and 352b, which are adjacent to each other, are not encapsulated in the corresponding dot 341, and the dots 341a and 341b are further apart than in the case of grade C.

For example, to be judged as grade F, the distance between particles, which is the distance between dots, must be 0.26 mm or more when dots exist in adjacent dot areas. This means that the distance between particles r must be 0.26 mm or more as the distance between the nearest sites mentioned above. In this case, the entire criteria dots 352a and 352b, which are adjacent to each other, are not encapsulated in the corresponding dot 341, and dots 341a and 341b are further apart than in grade D.

Thus, the reading determination unit 264 performs an inspection based on the displacement of the dot landing position relative to the criteria position using the superimposed image 36 and the determination grade criteria table 701. The 2D code detection unit 262 then reads the above inspected 2D code 34 data and decodes the 2D code.

In step 5, the reading determination unit 264 determines whether the result of the inspection based on the above displacement is above the determination grade “B”. If the reading determination unit 264 determines that the result of the inspection based on the above displacement is of the determination grade “B” or higher (step 5; Yes), the result of the inspection for the position displacement is acceptable, and the result of the inspection is displayed on the monitor 6. Then, in step 6, the dot position correction unit 265 generates a feedback signal for position displacement (e.g., a signal including correction data determined by adjusting the charge amount, etc., so that the dot to be hit is concentric with the criteria dot) and send the feedback signal to the inkjet recording unit 1. The inkjet recording unit 1 that receives the feedback signal reflects the feedback signal including the correction data for the position displacement in its parameters and continues printing. In this case, no correction is made for the evaluation items related to 2D code quality shown in FIG. 4. On the other hand, if the reading determination unit 264 determines that the result of the inspection based on the above displacement is not higher than the determination grade “B” (step 5; No), it proceeds to step 7.

In step 7, the 2D code decoded in step 4 is evaluated using the evaluation items (7 parameters based on ISO 15415) for 2D code quality shown in FIG. 4 and checked the judgment items that are less than B judgment as a result of the evaluation, The evaluation method for each item can be performed in accordance with ISO 15415.

In step 8, the reading determination unit 264 determines whether the determination items that resulted in less than B determination are determination items 1 to 4. If the reading determination unit 264 determines that the determination items that resulted in less than the B determination are determination items 1 to 4 (step 7; Yes), it proceeds to step 9 because they are determination items for parameters that can be corrected by the inkjet recording unit (“displacement width,” “reflection margin,” “unused error correction” and “position detection pattern damage”). On the other hand, if the reading determination unit 264 determines that the determination items that resulted in less than B determination are not determination items 1 to 4 (step 7; No), the determination items of parameters that cannot be corrected by the inkjet recording unit (“symbol contrast (SC), “symbol axis non-uniformity”, and “module placement non-uniformity”), go to step 11.

In step 9, the reading determination unit 264 displays on the monitor 6 an image diagram (FIG. 7) of the 2D code inspected in step 4 and determined in step 5. This allows the user to grasp the determination grade of the 2D code at a glance. At this time, the 2D code actually read may be displayed, as in the information indicating a warning described below. This allows the user to easily confirm what kind of 2D code was actually read.

In step 10, since the inspection result for position displacement was not passed, a feedback signal for position displacement is generated (e.g., a signal that includes correction data determined by adjusting the charge amount, etc. so that the landing dot is concentric with the criteria dot) so that the determination grade displayed on the monitor 6 is increased (e.g., from a grade “C” to a grade “A”) and also to generate an evaluation feedback signal to pass evaluation items 1 to 4 for 2D code quality shown in FIG. 4 that have failed (e.g., ISO/IEC 17025). The evaluation feedback signal (e.g., a signal including correction data determined by adjusting the charge amount, etc. to meet the quality criteria of ISO 15415) is generated and sent to the inkjet recording unit 1. Upon receiving these feedback signals, the inkjet recording unit 1 generates feedback signals including correction data for position displacement and evaluation feedback signals to pass evaluation items 1-4. The feedback signals are reflected in the parameters and printing continues. The correction data in step 10 is described below.

In step 11, since the determination items for parameters that are not correctable by the inkjet recording unit (“symbol contrast (SC)”, “symbol axis non-uniformity”, and “module placement non-uniformity”) have failed, the reading determination unit 264 displays warning information on the operation panel 12 to alert the administrator. Examples of warning information are described below.

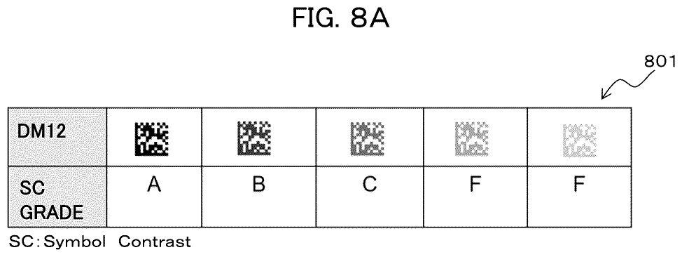

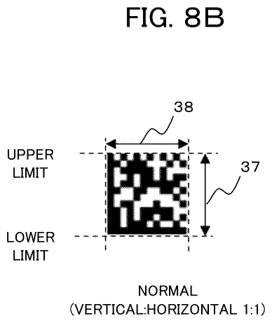

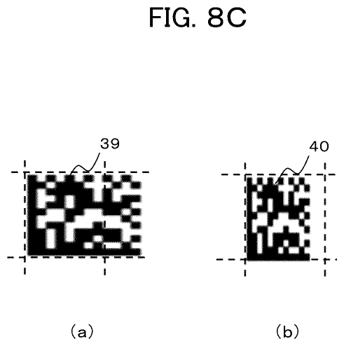

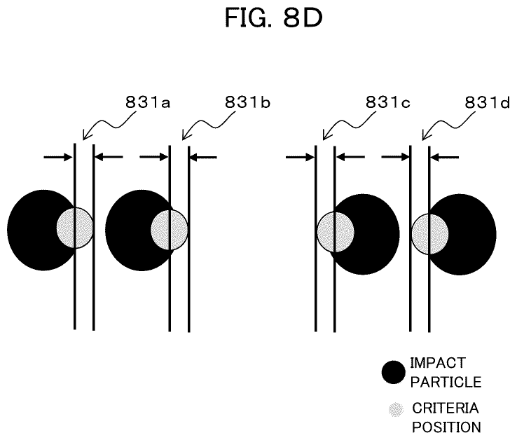

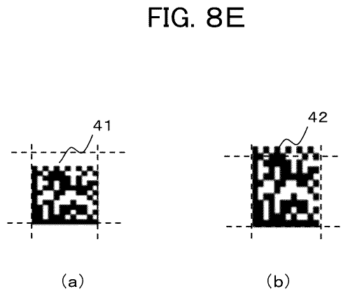

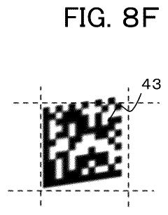

FIGS. 8A-8F illustrate examples of warning information. FIG. 8A shows an example of warning information about symbol contrast (SC). As shown in FIG. 8A, in the evaluation about symbol contrast (SC), the determination result becomes lower as the ink contrast becomes lighter, but as mentioned above, the ink contrast cannot be adjusted in inkjet recording unit. For this reason, even if the evaluation of symbol contrast is determined not to be above the predetermined evaluation (e.g., B or higher), the image of the 2D code (DM12) corresponding to the evaluated SC grade is displayed on the screen of operation panel 12 as warning information along with the SC grade in question.

One of the print evaluations that the 2D code is normal is that the rate of the horizontal length 38 to the vertical length 37 of the 2D code is 1:1, as shown in FIG. 8B. However, due to the speed at which the conveyor 3 conveys the printed object 2, or due to the printing distance between the print head and the printed object, the setting of the print head 33, and the effect of ink viscosity, faulty printing (FIGS. 8C, 8E, 8F) occurs, resulting in low evaluation. For example, as shown in FIG. 8C, 2D code 39 (a) and 2D code 40 (b) become longer or shorter in the horizontal direction than the set criteria length (the length of the frame surrounded by the dotted line) due to the influence of the unstable speed of conveyor 3. For the same reason, for example, 2D code 41 (a) and 2D code 42 (b), as shown in FIG. 8E, are vertically longer or shorter than the set criteria length (length of the frame enclosed by the dotted line), or 2D code 43, as shown in FIG. 8F, is displaced or distorted from the set criteria length (the length of the frame surrounded by the dotted line). In this way, even if the evaluation in “symbol axis non-uniformity” is determined to be not more than the predetermined evaluation (e.g., B or more), the evaluated 2D code is displayed on the screen of operation panel 12 as information indicating a warning.

In the inkjet recording unit, the vertical position of the dots can be fine-adjusted by adjusting the charge amount. However, if horizontal displacements 831a to 831d occur as shown in FIG. 8D, it is determined that correction is impossible, and the 2D code in which the horizontal displacement occurs is displayed on the screen of operation panel 12 as warning information, as in FIGS. 8A, 8B, 8C, 8E, 8F.

In step 10, the dot position correction unit 265 reads the correction data of the 2D code for which the result of the inspection based on the above displacement in step 5 is determined not to be “B” or higher in the determination grade “B” based on the image diagram of the determination grade indicating the displacement of the impacted particle displayed in step 9. The correction data is data that stores the correction amount of dots comprising the 2D code (e.g., a correction value to adjust the charge amount of dots to meet the quality criteria of ISO 15415), which is associated with the determination grade.

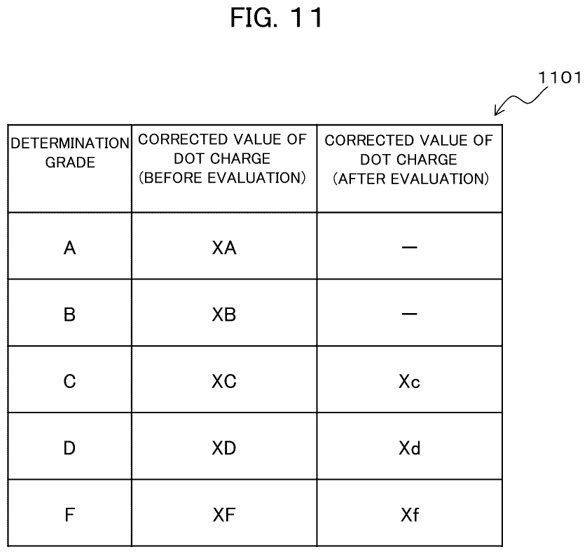

FIG. 11 shows an example of a correction data table that defines correction values for adjusting the charge amount of dots. As shown in FIG. 11, the correction data table 1101 stores the determination grade and the correction value of the dot charge amount (the correction value before and after the evaluation by the determination item) in correspondence. To illustrate an example, in the case of a 2D code where the displacement of the dot landing position relative to the criteria position is determined to be the determination grade “C,” the correction value “XC” for setting each dot in the criteria position is stored a smaller value than the correction value “XD” for setting each dot in the criteria position in the case of a 2D code determined as judgment grade “D”. In other words, the correction data table 1101 is created so that the higher the determination grade, the smaller the correction value for the charge amount of the dots.

For example, in the case of 2D code in which the displacement of the dot landing position relative to the criteria position is determined to be of the determination grade “C”, furthermore, evaluation is performed using the evaluation items related to 2D code quality (7 parameters based on ISO15415) shown in FIG. 4. The correction value “Xc” for setting each dot a criterion position, which is determined according to the result of the evaluation, is the same as the correction value “Xc” for setting each dot a criterion position in the case of 2D code determined to be of determination grade “D”. The correction value “Xc” is smaller than the correction value “Xd” for setting each dot a criterion position in the case of a 2D code that is determined to have a determination grade “D”. The correction value “Xc” for setting each dot at the criterion position determined according to the result of the evaluation is stored a value smaller than the correction value “Xd” for setting each dot at the criterion position in the case of a 2D code determined as grade “D”. In other words, the correction data table 1101 is created such that the higher the evaluation result, the smaller the correction value of the charge amount of the dot. In this example, the correction value based on the grade determination result and the correction value based on the evaluation result are different, but the same correction value may be used. The correction data can be stored in ROM 31 in advance.

When the dot position correction unit 265 reads such correction data from ROM 31, the 2D code whose grade has been determined is corrected with a correction value corresponding to the determined grade. For example, as shown in the determination grade criteria table 701 in FIG. 7, if the dot position is higher than the criterion position, the charging voltage data may be adjusted so as to lower the charging voltage so as to be at the position of the criteria dot. If the dot position is lower than the criterion position, the charging voltage data may be adjusted so as to increase the charging voltage to the position of the criteria dot. The dot position correction unit 265 reflects the evaluation feedback signal including such correction data in the ROM 10 of the inkjet recording device 1 via communication means (cable, wireless, etc.), the printing inspection unit interface 15, and the bus line 17. Thereafter, returning to step 1, the MPU7 of the inkjet recording unit 1 controls the operation of the print head 33 with the set contents to print 2D code reflecting the correction data on the printed object 2. In this example, the case where 2D code is the inspection target is described, but as mentioned above, various character patterns, such as English letters and numbers, may be included.

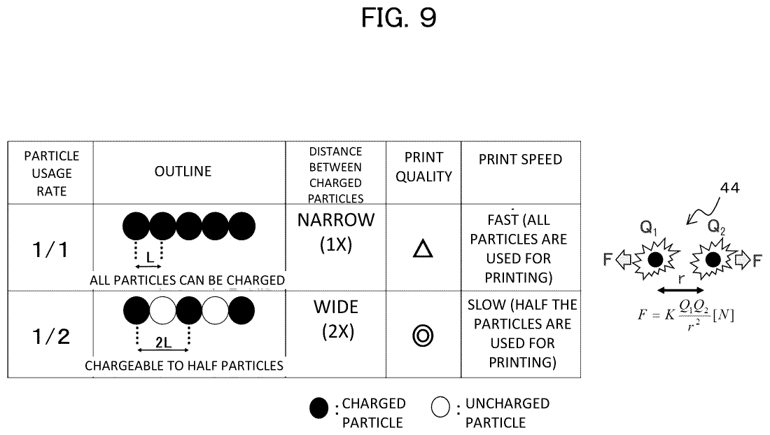

FIG. 9 illustrates an example of a print quality degradation factor for the inkjet recording unit. Particle usage rate represents the rate of particles that can be charged to the generated particles. A particle usage rate of 1/1 means that all generated particles can be charged. In this case, all particles are available for printing, and the printing speed is faster. However, since the distance L between the particles to be charged becomes shorter, the Coulomb repulsive force 44 acts significantly, and there is a problem of poor print quality. In this case, the Coulomb repulsive force 44 causes the Coulomb force to work significantly, and due to its effect, there are cases where it is difficult to meet the condition of grade B, which is the acceptance criteria among the determination grades shown in FIG. 6 (the distance between dots, the distance between the impacted particles, is within 0.06 to 0.15 mm).

On the other hand, when the particle usage rate is ½, half of all particles generated are charged, so the Coulomb repulsive force 44 is also reduced. Therefore, in this case, the distance between charged particles is large and the print speed is reduced, but the print quality is better. However, in some charging algorithms that use the above-mentioned correction data to adjust the charge amount of dots, printing distortion tends to occur at positions where the charge amount is greater than a certain level and even if the particle usage rate is ½ or more (⅓ to ⅛), there are cases where it is not possible to make corrections that result in a determination grade of B or higher or that meet the quality criteria of ISO15415. Specifically, if the determination grade does not reach or exceed the determination grade B more than a predetermined number of times in Step 5 of the automatic correction feedback process shown in FIG. 5, and the situation where Steps 9 and 10 are repeatedly performed continues, the 2D code may be stored in ROM 31, or information indicating a warning may be displayed on the operation panel 12 as in Step 11.

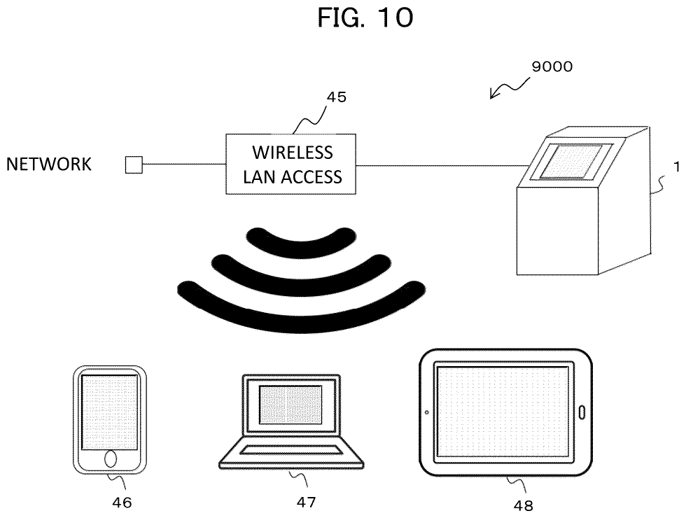

FIG. 10 shows an example of a wireless run system to which this system is applied. As shown in FIG. 10, in the wireless run system 9000, the inspection results displayed on the inkjet recording unit 1 are sent via the wireless LAN access point 45 and displayed on the display or touch panel of a terminal device with a common hardware configuration. The inspection results can be, for example, the result of inspection based on the displacement of the dot landing position relative to the criteria position in step 5 of the automatic correction feedback process shown in FIG. 5, or the result of the 2D code quality evaluation item in step 7 (ISO 15415). The terminal device can be a communication-capable terminal or equipment with a common hardware configuration, such as a smartphone 46, PC (Personal Computer) 47, tablet terminal 48, etc.

In addition to such display of the inspection and the evaluation results, for example, the above-mentioned correction data may be displayed on the screen of the above-mentioned terminal device, and the input device (for example, a keyboard or a touch panel) may accept an operation from a user to adjust the charge amount of a dot according to the judgment grade. The above terminal device may send the adjusted correction data to ROM 10 of inkjet recording unit 1, reflect it in the correction data used in step 10 of FIG. 5, and print it. This allows printing to continue in real time by reflecting the correction data in which the user has adjusted the charge amount of dots, etc., even when information indicating a warning due to printing failure is displayed.

As described above, in this example, the inkjet printer (inkjet recording unit 1) ejects ink onto a print target (e.g., printed object 2) and prints predetermined information (e.g., 2D code) comprising dots formed by the ejected ink onto the print target. The camera 5 captures images of the predetermined information printed on the print target. The detection unit (e.g., 2D code detection unit 262) detects the printing area (e.g., an area where a 2D code 34 is printed) of the predetermined information from the image captured the predetermined information, the criteria position grid unit (e.g., criteria position grid unit 263) divides the detected printing area into predetermined dot areas 351 and generating a criteria position grid 35 in which each of the divided dot areas 351 is assigned with a dot 352 as a criteria for inspecting the landing position, the reading determination unit (e.g., reading determination unit 264) inspects the dot landing position relative to the criteria dot position based on a superimposed image 36 of the printing area and the criteria position grid and a determination grade criteria table 701 to determine the degree of displacement of the dot landing position relative to the criteria dot position, the processing unit (e.g., printing inspection unit 4) includes the dot position correction unit (e.g., dot position correction unit 265) generates a feedback signal for correcting the dot landing position based on the result of the inspection and the correction data (e.g., the correction value before the evaluation defined in the correction data table 1101) defining the correction amount of the dots comprising the printing area determined according to the degree of the displacement and outputs to the inkjet printer, the inkjet printer ejects ink on the print target based on the corrected dot landing position obtained from the feedback signal.

Therefore, it is possible to properly evaluate the print information (e.g., 2D code) printed by inkjet printers and perform feedback control based on such evaluation. For example, by making a grid of the criterion positions of the impacted particles during the printing process and inspecting the position displacement of the printed image actually printed, it is no longer necessary to register a reference character pattern as a criteria, and it is possible to provide a system that can determine the quality of printing and automatically correct it.

In addition, printing is continued by automatically reflecting feedback signals including the above-mentioned correction data and evaluation feedback signals, which enables accurate printing with stable print quality.

As described in step 6 and step 10 of FIG. 5, the dot position correction unit generates the feedback signal using the correction data determining the correction amount of the dot by adjusting the charge amount for the ink particles, the inkjet printer ejects ink with the charge amount adjusted to the print target. Therefore, high-quality printing with ink adjusted so that the dots are in the criterion position is possible.

As described in step 7 and step 8 of FIG. 5, the reading determination unit can determine whether a determination item (for example, the determination item table 401 that defines evaluation criteria according to ISO 15415) for determining whether or not printing on the print target meets a predetermined evaluation criteria is an item that can be corrected by an inkjet printer, when the detection unit detects a 2D code as the printing area of the predetermined information, the dot position correction unit generates evaluation correction data (e.g., the correction value after evaluation as defined in the correction data table 1101) meets the predetermined evaluation criteria when it is determined that the item is a correctable item as described in step 10, generates an evaluation feedback signal for correcting the dot landing position using the generated evaluation correction data and outputs the evaluation feedback signal and the feedback signal to the inkjet printer. Therefore, high-quality printing with ink whose dot position is adjusted to meet both the determination grade and the evaluation criteria is possible.

The inkjet printer includes an operation panel 12 for inputting setting information on printing, displays information on the correction data (e.g., the H correction value shown in FIG. 11) included in the feedback signal output from the processing unit on the operation panel, accepts input from a user of a value (e.g., any value desired by the user) for adjusting a charge amount for the ink particles included in the correction data, ejects ink with the charge amount adjusted based on the value onto the print target. This allows the user to manually set the value to the user's desired value even if the automatically adjusted correction value is not the user's intended value.

When the inkjet recording system includes a terminal (e.g., the various terminal devices shown in FIG. 10) connected via a network, and the terminal includes a display unit such as a display or a touch panel and an input unit such as a keyboard or a touch panel, the inkjet printer sends information on the correction data displayed on the operation panel to the terminal, and ejects the ink with adjusted charge amount to the print target based on a value for adjusting the charge amount for the ink particles included in the correction data received from the terminal, the terminal displays the information on the correction data sent from the inkjet printer on the display unit, receives the input unit input of a value for adjusting the charge amount from the user, and sends the value to the inkjet printer. This allows the correction value to be manually set to the user's desired value by remote control.

In addition, if the reading determination unit determines that each of the items (a) displacement width, (b) reflection margin, (c) unused error correction, and (d) position detection pattern damage, among the items included in the ISO 15415 determination items, are the items that can be corrected above, the dot position correction unit generates the evaluation correction data for each of the items (a) to (d), and generates the evaluation feedback signal using the evaluation correction data. This makes it possible to correct the items included in the ISO 15415 determination items to meet the criteria, thus enabling high-quality printing.

When the reading determination unit determines that each of the items included in the ISO 15415 determination items, (e) symbol contrast (SC), (f) symbol axis non-uniformity, and (g) module placement non-uniformity, are items that cannot be corrected, and displays on the screen or otherwise output warning information (e.g., information indicating warnings as shown in FIGS. 8a to 8f) to alert the administrator for each of the items (e) to (g). This allows the user to grasp at a glance the state of the predetermined information (e.g., 2D code) comprises the dots that are evaluated for the ISO 15415 determination items that cannot be corrected.

The above examples are not limited to the above examples, but include various variations. The above examples are described in detail for the purpose of explaining the invention in an easy-to-understand manner, and are not necessarily limited to those with all the described configurations.

### REFERENCE SIGNS LIST

1 . . . Inkjet recording unit
2 . . . Print object
3 . . . Conveyor
4 . . . Printing inspection unit
5 . . . Camera
6 . . . Monitor
7 . . . MPU (micro processing unit)
8 . . . Print speed circuit
9 . . . RAM (random access memory)
10 . . . ROM (read-only memory)
11 . . . Display unit
22a . . . Negative deflection electrode
22b . . . Positive deflection electrode
23 . . . Deflection power
24 . . . Gutter
25 . . . Print target detection circuit
26 . . . Image processing unit
31 . . . Inspection unit ROM
261 . . . Image processing circuit
262 . . . 2D code detection unit
263 . . . Criteria position grid unit
264 . . . Reading determination unit
12 . . . Operation panel
13 . . . Print control circuit
14 . . . Video RAM
15 . . . Printing inspection unit interface
16 . . . Charging voltage generator circuit
17 . . . Bus line
18a . . . ink
18b . . . Charged ink particles
19 . . . ink container
20 . . . nozzle
21 . . . charged electrode
32 . . . Input/output unit
33 . . . Print head
34 . . . 2D code (DM) example
35 . . . Gridding of criteria positions
36 . . . Dot landing position vs.
37 . . . Criteria vertical length
38 . . . Criteria horizontal length
39-43 . . . Examples of faulty print
44 . . . Coulomb repulsion strain
45 . . . wireless LAN access
46-48 . . . terminal device
265 . . . dot position correction unit
1000 . . . inkjet recording system
1101 . . . correction data table

1. An inkjet recording system comprising:
an inkjet printer for ejecting ink onto a print target and printing predetermined information comprising dots formed by the ejected ink onto the print target;
a camera capturing images of the predetermined information printed on the print target;
a detection unit for detecting the printing area of the predetermined information from the image captured the predetermined information,
a criteria position grid unit for dividing the detected printing area into predetermined dot areas and generating a criteria position grid in which each of the divided dot areas is assigned with a dot as a criteria for inspecting the landing position;
a reading determination unit for inspecting the dot landing position relative to the criteria dot position based on a superimposed image of the printing area and the criteria position grid and a determination grade criteria table to determine the degree of displacement of the dot landing position relative to the criteria dot position,
a processing unit including a dot position correction unit for generating a feedback signal for correcting the dot landing position based on the result of the inspection and the correction data defining the correction amount of the dots comprising the printing area determined according to the degree of the displacement and outputting to the inkjet printer,
wherein the inkjet printer ejects ink on the print target based on the corrected dot landing position obtained from the feedback signal.

2. The inkjet recording system according to claim 1,
wherein the dot position correction unit generates the feedback signal using the correction data determining the correction amount of the dot by adjusting the charge amount for the ink particles,
wherein the inkjet printer ejects ink with the charge amount adjusted to the print target.

3. The inkjet recording system according to claim 1,
wherein the reading determination unit determines whether a determination item for determining whether or not printing on the print target meets a predetermined evaluation criteria is an item that can be corrected by an inkjet printer, when the detection unit detects a 2D code as the printing area of the predetermined information,
wherein the dot position correction unit generates evaluation correction data meets the predetermined evaluation criteria when it is determined that the item is a correctable item, generates an evaluation feedback signal for correcting the dot landing position using the generated evaluation correction data and outputs the evaluation feedback signal and the feedback signal to the inkjet printer.

4. The inkjet recording system according to claim 2,
the inkjet printer includes an operation panel for inputting setting information on printing, displays information on the correction data included in the feedback signal output from the processing unit on the operation panel, accepts input from a user of a value for adjusting a charge amount for the ink particles included in the correction data, ejects ink with the charge amount adjusted based on the value onto the print target.

5. The inkjet recording system according to claim 4,
the inkjet recording system includes a terminal connected via a network,
the terminal includes,
a display,
an input unit,
wherein the inkjet printer sends information on the correction data displayed on the operation panel to the terminal, ejects the ink with adjusted charge amount to the print target based on a value for adjusting the charge amount for the ink particles included in the correction data received from the terminal,
wherein the terminal displays information on the correction data sent from the inkjet printer on the display unit, receives the input unit input of a value for adjusting the charge amount from the user, and sends the value to the inkjet printer.

6. The inkjet recording system according to claim 3,
wherein the reading determination unit determines that each of the items included in the ISO 15415 determination items, (a) displacement width, (b) reflection margin, (c) unused error correction, and (d) position detection pattern damage, is an item that can be corrected,
wherein the dot position correction unit generates the evaluation correction data for each of the above items (a) to (d), and generates the evaluation feedback signal using the generated evaluation correction data.

7. The inkjet recording system according to claim 3,
wherein the reading determination unit determines that each of the items included in the ISO 15415 determination items, (e) symbol contrast (SC), (f) symbol axis non-uniformity, and (g) module arrangement non-uniformity, are items that cannot be corrected, and outputs warning information to alert the administrator for each of the items (e) to (g).

8. A print information correction method for correcting predetermined information comprising dots formed by ink, printed on a print target by an inkjet printer, the print information correction method comprising:
capturing an image of the predetermined information printed on the print target by a camera,
detecting the printing area of the predetermined information from the image in which the predetermined information by a detection unit,
dividing the detected printing area into predetermined dot areas and generating a criteria position grid in which each of the divided dot areas is assigned with a dot as a criterion for inspecting the landing position by a criteria position grid unit,
inspecting the dot landing position relative to the criteria dot position based on a superimposed image of the printing area and the criteria position grid and a determination grade criteria table to determine the degree of displacement of the dot landing position relative to the criteria dot position by a reading determination unit,
generating a feedback signal to correct the dot landing position based on the results of the inspection and the correction data that defines the amount of correction of the dots comprising the printing area determined according to the degree of displacement and outputting the signal to the inkjet printer by a dot position correction unit,
ejecting the ink on the print target based on the corrected dot landing position obtained from the feedback signal by the inkjet printer.
